(19) United States
(12) Patent Application Publication
(10) Pub. No.: US 2021/0006427 A1
(43) Pub. Date: Jan. 7, 2021

(54) METHOD OF CONFIGURATION AND/OR OF MAINTENANCE OF A HOME-AUTOMATION SYSTEM FOR A BUILDING AND ASSOCIATED HOME-AUTOMATION SYSTEM CONFIGURATION DEVICE

(71) Applicant: SOMFY ACTIVITES SA, CLUSES (FR)

(72) Inventor: Sylvain FARGIER, CLUSES (FR)

(21) Appl. No.: 16/643,992

(22) PCT Filed: Sep. 3, 2018
(86) PCT No.: PCT/EP2018/073607

§ 371 Date: Mar. 3, 2020

(30) Foreign Application Priority Data
Sep. 4, 2017 (FR) 1758143

(51) Int. Cl. H04L 12/28; H04L 29/08; G05B 15/02

(52) U.S. Cl. CPC H04L 12/2821; H04L 67/12; H04L 12/282; G05B 2219/2642; G05B 15/02; H04L 12/2832; H04L 12/2809

(57) ABSTRACT

This method for configuring a home-automation system for a building includes a plurality of communicating elements so as to perform a plurality of home-automation functions and a communication network to which the communicating elements are connected, each communicating element including a network interface possessing a network address and implementing one or more software objects modelling this communicating element in the form of resources of at least three types: input, output and logic unit. The method includes steps of:—discovering the various communicating elements of the communication network,—mapping, in the communication network, the resources that each communicating element discovered offers,—programming the home-automation functions of the home-automation system while taking account of the mapping of the resources in the communication network.

### BACKGROUND OF THE INVENTION

### Field of the Invention

This invention concerns a method for configuring and/or maintaining a home automation system for a building and an associated home automation system configuration device.

More generally, the invention relates to the field of building automation, both for commercial buildings and residential buildings, whether single- or multi-unit.

### Description of the Related Art

There are numerous buildings equipped with controllable devices to carry out comfort and energy management functions such as heating, ventilation, and air condition, as well as lighting management and shutter monitoring, such as awnings or rolling shutters placed in front of windows of the building, or provide remote security functions by controlling locking systems (doors, locks). Automation refers to sets of rules governing the control of electrical devices by a programmable monitoring system in order to ensure greater comfort for the occupants of the building or to optimise energy consumption. These automated systems are controlled by a programmable monitoring system in order to ensure the comfort of the occupants of the building or to optimise energy consumption. These applications are referred to as ‘building management’, or, more generally as ‘Building Automation Systems’. In the residential field, automation systems are more frequently referred to as ‘home automation’. For the sake of simplicity, the term ‘home automation’ will be used below to refer both to residential and tertiary applications.

Typically, the devices of a single building are connected to a control unit, the function of which is to monitor the devices and control their operation. This connection is frequently made by connecting the equipment by means of dedicated wired links. For example, each device is directly connected to the control unit by means of one or more cables in a master-slave configuration.

However, this situation is not always satisfactory, because even the slightest modification of the home automation system or the operation of the devices necessitates rewiring the system, which is costly and complicated, requiring recourse to specialised installers.

In other known systems, this connection is made by connecting the devices to a common data bus, such as a multipoint bus that allows for bidirectional connections, e.g. RS485. This data bus is connected to the central unit so as to form a network that allows for the exchange of data between the devices and the control unit.

However, this situation does have its disadvantages.

On the one hand, the installation of the system is more complicated because the devices must each be manually configured in order to configure their operation and make them capable of communicating over the network. Thus, apart from the already-burdensome wiring operation, an additional step of network configuration is required, which itself necessitates the involvement of specialised installers.

Moreover, to a certain extent, this situation also offers limited flexibility, because any post-installation modification requires the network to be rewired, whether to add new devices or to modify their distribution within the building.

On the other hand, this known situation has limits in terms of the number of devices that can be included within the network. For example, the RS485 solutions currently used have limited addressing capabilities, and, in practice, only allow for a maximum of 255 individual devices to be connected to a single bus. This limit is prohibitive when equipping large buildings and/or buildings comprising a large number of devices to manage. Contemporary applications make it necessary to be able to manage ever greater numbers of devices, e.g. in the context of the Internet of Things (IoT) or ‘smart’ building management.

Moreover, the architecture of these known networks may result in increased latency times during communications between a device and the control unit. This is explained, in particular, by the fact that control is centralised, and the information transmitted by the devices must return to the bus in order to be centrally processed by the control unit. For some applications, excessive latency may result in dissatisfaction on the part of users wishing to use the device, or adversely affect the operation of the equipment. It is also possible to organise the devices of the building in communications networks.

In home automation systems for buildings, the communicating devices (home automation devices or network devices) are used at very low frequencies. For example, an actuator is used four times a day on average, i.e. a total usage of roughly five minutes per day. Thus, it is inactive nearly 99.7% of the time. Each communicating device comprises one or more microprocessors, which are also underutilised. Indeed, in a home automation system comprising several communicating devices, much of the computing power of the home automation system is unused.

In other known home automation systems for buildings, the home automation system is managed by a central control unit capable of carrying out a predefined number of functionalities. One problem arises when one wishes to upgrade the home automation system. If the capacity limit of the control unit has been reached, no additional function can be added without changing the central control unit. Likewise, in such a home automation system, it is not possible to add a functionality that is not handled by the central command unit without changing the central command unit.

The same problem arises when users wish to reconfigure their home automation systems that are controlled by control units that centralise all controls in the system. Generally speaking, such a home automation system offers very little adaptability in terms of increasing the number of functionalities beyond what was initially provided for when the system was installed.

### SUMMARY OF THE INVENTION

More specifically, this invention seeks to address some or all of these disadvantages by proposing a simple solution for configuring or reconfiguring a home automation system for a building and for maintaining that home automation system.

To this end, the invention concerns a method for configuring a home automation system for a building executed by a configuration device, wherein the home automation system comprises a plurality of communicating devices in order to carry out a plurality of home automation functions and a communications network to which the communicating devices are connected, wherein each communicating device comprises a network interface having a network address and implementing one or more software objects that model the communicating device in the form of resources of at least three types: input, output, and logical unit,

wherein the method comprises the steps of:
discovering the different communicating devices of the communications network,
mapping the resources offered by each communications device discovered on the communications network,
programming home automation functions of the home automation system, taking into account the map of the resources on the communications network.

The invention makes it possible for a large number of home automation devices within the building to be managed over the communications network whilst providing increased flexibility in terms of installation and upgrading.

According to aspects of the invention that are advantageous, but not mandatory, such a method may include one or more of the following features, taken alone or in any combination technically possible:
The step of resource mapping comprises a sub-step of enumerating the resources offered by each communicating device discovered and a sub-step of associating a resource identifier with each resource enumerated.
The programming step consists of establishing links between the inputs, logical units, and outputs and configuring the logical units in order to process data provided by the inputs and transmit the result of the processing to the outputs in order to control them.
The programming step consists of transmitting the links established to at least some resources.
The links between the inputs, the logical units, and the outputs are automatically established by the configuration device depending on libraries stored in a memory zone of the configuration device.
The execution of the method is divided between several distinct logical units distributed within the communications network.
The method is automatically executed by the configuration device after it connects to any point on the communications network.

In another aspect, the invention concerns a home automation system for a building, wherein the home automation system is configured by the configuration method according to any of the foregoing claims, wherein the home automation system is characterised in that it comprises a plurality of communicating devices in order to carry out a plurality of home automation functions and a communications network to which the communicating devices are connected, wherein each communicating device comprises a network interface having a network address and implementing one or more software objects that model the communicating device in the form of resources of at least three types: input, output, and logical unit.

According to aspects of the invention that are advantageous, but not mandatory, such a system may include one or more of the following features, taken alone or in any combination technically possible:
Each resource is identified by a unique resource identifier containing the network address of the network interface of the communicating device modelled, at least in part, by the resource.
A sensor or a control point is modelled in the form of at least one input.
A controllable home automation device is modelled in the form of at least one output.
A network device is modelled in the form of at least one logical unit.
The communications network is arranged in the form of a hierarchical network.

In another aspect, the invention concerns a method for maintaining a home automation system for a building as described above, wherein the home automation system is configured by the configuration method as described above, wherein the maintenance method comprises the steps of:
discovering different communicating devices of the communications network,
mapping resources offered by each communications device discovered on the communications network,
recovering the various links between the resources of each communicating device discovered, as well as their status.

According to aspects of the invention that are advantageous, but not mandatory, such a method may include one or more of the following features, taken alone or in any combination technically possible:
The method further comprises a step of reprogramming home automation functions of the home automation system whilst taking into account a new map of the resources on the communications network and/or new home automation functions to be carried out.
The method further comprises a step of correcting defective resources and/or links.

### BRIEF DESCRIPTION OF THE DRAWINGS

The invention will be better understood, and other advantages thereof will become clearer, in the light of the following description of an embodiment of a home automation system for a building, provided by way of example only and by reference to the attached drawings, in which:

FIG. 1 is a schematic representation of a device comprising a home automation system according to the invention;

FIG. 2 is a schematic representation of a communications network of the home automation system of FIG. 1 to connect devices of the home automation system;

FIG. 3 is a schematic representation of a network interface used in devices of the home automation system belonging to the communications network of FIG. 2;

FIG. 4 is a schematic representation of a network device used in the communications network of FIG. 2;

FIG. 5 is a schematic representation of a software representation of one of the home automation devices of the home automation system within an API implemented by a software layer of the home automation system.

### DESCRIPTION OF THE PREFERRED EMBODIMENTS

Below, the invention will be described by reference to a particular embodiment in which the network architecture of the building home automation system corresponds to the architecture of the building. This example is by no means limiting, and the invention may be applied to other network architectures.

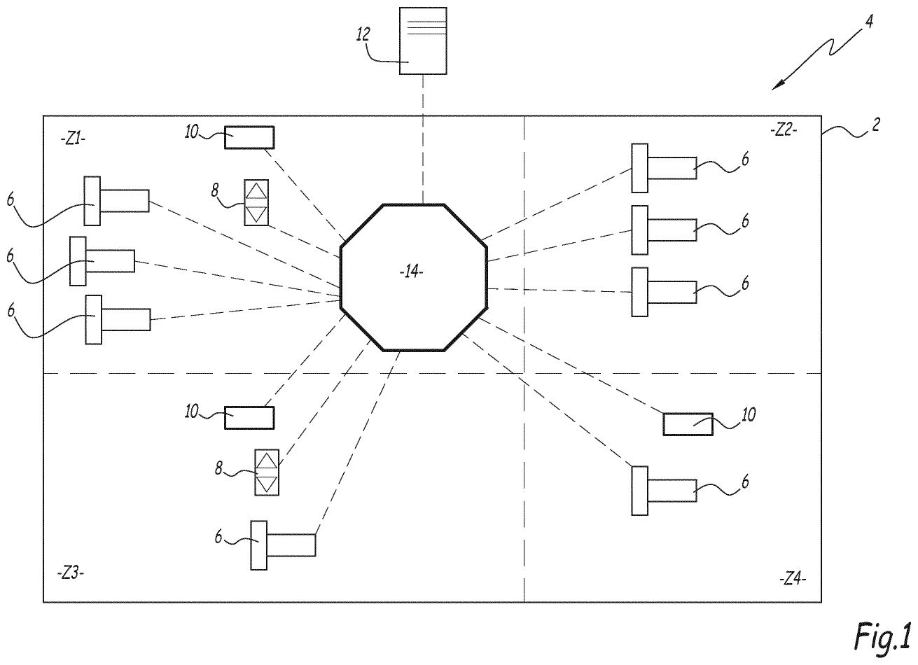

FIG. 1 shows a building 2, comprising several zones Z1, Z2, Z3, Z4. The building 2 is equipped with a home automation system 4 including a group of home automation devices distributed in the zones of the building 2, as well as a system for controlling these home automation devices.

Here, the home automation system 4 is meant to provide comfort and/or energy management functions for the building 2, such as heating, ventilation, and air conditioning, as well as functions such as lighting management, control of shutters, such as awnings or rolling shutters placed in front of the windows of the building 2, and/or security functions such as room monitoring and alarms.

The group of home automation devices comprises home automation devices such as controllable home automation devices 6, control points 8, and sensors 10.

In particular, the control system includes a programmable control unit 12 and a communications network 14 internal to the building 2, wherein the communications network 14 is arranged so as to allow the home automation devices of the home automation system 4 to communicate with the control unit 12. In the following, the home automation devices of the home automation system 4 that are connected to this communications network are said to ‘belong to’ the communications network 14.

Here, the home automation devices and the control system are connected to one or more electrical power sources (not shown) of the building 2.

The zones of the building 2 correspond to portions of the building 2 that are inside and/or outside the building and each intended to receive some of the home automation devices of the home automation system 4.

The building 2 may be a group of buildings or a residential building, or a commercial or industrial building, or any combination of such uses. In particular, it may be a block of flats or an individual house.

Thus, within the meaning of this invention, the term ‘home automation’ is not limited to purely domestic and residential uses.

For example, zones of the building 2 correspond to levels of the building 2, such as floors of basements. These zones may also be rooms or groups of rooms of the building 2, which may be separated from one another by means of walls; these rooms may be distributed within one or more levels of the building 2. These zones may also correspond to façades or parts of a façade, such as a part of a façade corresponding to a single floor. These areas may be delimited independently of the physical structure of the building 2. For example, a single room of the building 2 may include several zones. Such zones may also be located outside the building 2, e.g. when they correspond to a façade or a portion of a façade of the building 2.

For example, these zones are defined during the design of the building 2 and/or the design and/or installation of the home automation system 4.

Preferably, the zones of the building 2 are distinct from one another. However, in one variant, the zones of the building 2 may overlap or be nested within one another.

In this example, only four zones, designated as Z1, Z2, Z3, and Z4, are defined in reference to the building 2. However, in practice, this number may be different. In particular, it is adapted depending on the configuration of the building 2 and the functions of the home automation system 4.

To simplify FIG. 1, the zones Z1, Z2, Z3, and Z4 are illustrated schematically within a single floor of the building 2.

Preferably, each controllable home automation device 6 includes an actuator that can be controlled by means of at least one control signal.

Here, the controllable home automation devices 6 are illustrated as being identical. However, they may be different and have different functions within the home automation system 4.

For example, the actuator of the device 6 contains an electric motor that is coupled with a mechanical load and arranged so as to move and/or control an element of the building 2.

In one example, the mechanical load of the device 6 is a shutter, such as a panel, an awning, or an opaque curtain associated with at least one opening of the building 2, such as a window or a bay window. The movement of this shutter allows the amount of sunlight received by the building 2 through this opening.

In another example, the mechanical load of the device 6 is a compressor adapted to carry out an expansion-compression cycle of a coolant within the cooling system of the building 2, such as an air conditioner or a heat pump, in order to control the internal temperature of the building 2.

In yet another example, the mechanical load of the device 6 is a pump or fan intended to move a volume of fluid within the building 2, e.g. to aspirate or blow air within a ventilation system, or to circulate water or coolant within a dedicated conduit.

In one variant, the actuator of the device 6 may control an electrical switching device in order to turn on and off a light source, such as a battery of glow lamps or LED lamps, within the building 2.

The controllable home automation device 6 may also be a light, e.g. an interior or exterior light or a lighting control system, an alarm system, or a video camera, in particular a CCTV camera.

A control point 8 is intended to receive control instructions from a user of the building 2 in order to control, directly or indirectly, one or more of the controllable home automation devices 6 and/or to control the control unit 12.

To this end, each control point 8 here includes a human-machine interface (not shown), comprising data entry means, such as one or more switches and/or one or more pushbutton switches and/or one or more knobs and/or a touchscreen. The control point 8 may also include a connection interface to connect external control means, e.g. one or more individual switches arranged around the control point 8 and connected to it by means of a wired connection.

The human-machine interface of the control point 8 may also include display means, such as light indicators and/or an electronic screen, e.g. an LCD screen, to show the user information related to the operation of the home automation system 4 or instructions entered on the human-machine interface.

The control points 8 may take the form of a portable remote control associated with a fixed receiver or, in one variant, a fixed control terminal attached to a wall of the building 2.

Here, too, the control points 8 are shown as being identical, but they may be different, and be responsible for different functions within the home automation system 4.

Each sensor 10 is intended to convert one or more physical values related to the status of the building 2, its environment, or a home automation device into one or more signals proportional to this physical value. For example, this signal may be an electrical signal, a light signal, or a radio frequency (RF) signal. This signal may be transmitted by the sensor to one or more home automation devices and/or the control system, e.g. to the control unit 12.

One or more sensors 10 maybe incorporated in a controllable home automation device 6, a control point 8, or the control unit 12. The home automation installation 4 may also comprise one or more sensors independent of these elements.

For example, the physical values measured by the sensors 10 are, by way of example only, a temperature, e.g. a temperature of a wall or the ambient air, a humidity level, a luminosity value, an ambient air pressure value, a consumption value, e.g. water, gas, or electricity consumption, the open/closed state of a shutter, the position of a shutter, e.g. on a window, motorised or otherwise, or the presence or absence of a user.

Here, too, the sensors 10 are shown as being identical, but they may be different from one another within the home automation system 4.

Generally, each home automation device comprises a network interface 40, which allows it to communicate over the network 14, and will be described in greater detail in the description.

By way of example only, in FIG. 1, the zone Z1 includes three controllable home automation devices 6, a control point 8, and a sensor 10. The zone Z2 includes three controllable home automation devices 6. The zone Z3 includes a home automation device 6, a control point 8, and a sensor 10. The zone Z4 includes a home automation device 6 and a sensor 10.

For example, the three controllable home automation devices 6 of the zone Z2 are adapted to move shutters on openings of the building 2 that are arranged in this zone Z2. Continuing in this example, the controllable home automation devices 6 of the zone Z1 here are part of an air conditioning and cooling system for the air circulating in the zone Z1. Their operation is regulated by means of control commands received by the control point 8 and depending on a temperature measured by the sensor 10 located in this zone Z1.

Each home automation device of the home automation system 4, in particular the devices 6, the control points 8, and the sensors 10, is connected to the control unit 12 by means of the communications network 14, and, to this end, includes a network interface 40 to connect to this communications network 14.

For example, each home automation device 6 receives control signals via the communications network 14. Each control point 8 transmits control orders received via the communications network 14. Each sensor 10 sends the information measured via the communications network 14.

Communications are carried out according to a given communications protocol.

For example, communications are carried out by exchanging messages, e.g. in the form of packets, with each of these messages containing a header that includes a destination of the message and useful data, e.g. a control order or a physical value measured by a sensor.

Preferably, the communications protocol used is IP (Internet Protocol), e.g. IPv6. In one variant, the communications protocol is the IPv4 protocol.

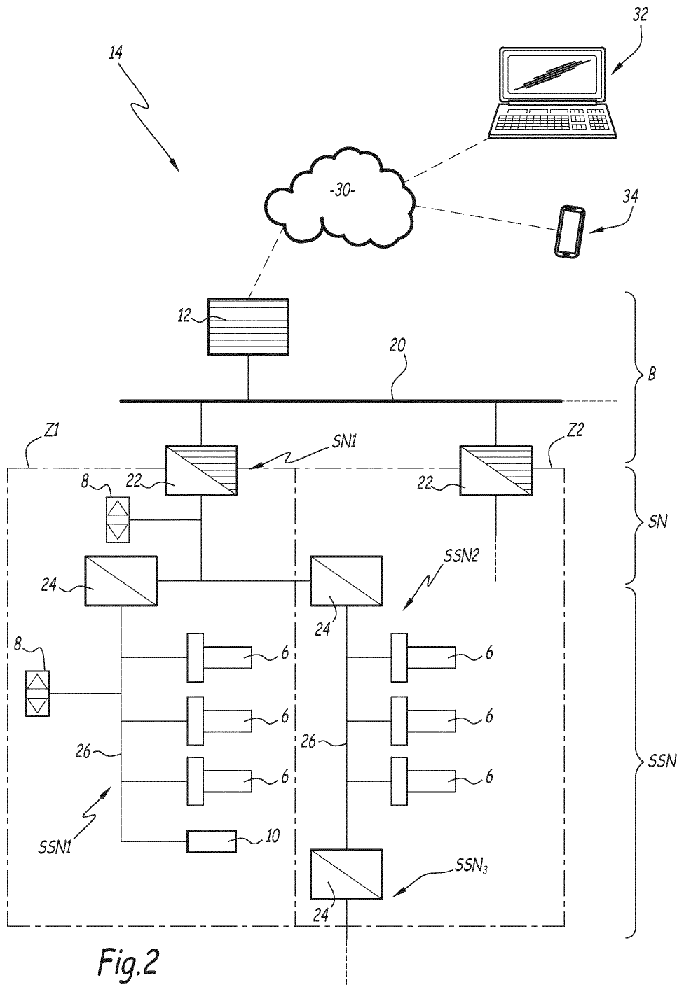

FIG. 2 shows the exemplary communications network 14 of FIG. 1 in greater detail. To facilitate the understanding of this FIG. 2, the home automation devices 6, 8, 10 associated with the zones Z3 and Z4 of the building 2 are not shown.

The communications network 14 is a hierarchical network having multiple hierarchical levels or ‘ranks’. It includes a main network B, which comprises, in particular, a common data bus forming a backbone 20 to which the control unit 12 is connected.

The communications network 14 also includes at least one subnet, generically indicated by the reference ‘SN’. This subnet includes a network device 22, 24 that is directly connected to the backbone 20 by means of a network interface 40 and forms the head of this subnet SN. It may be a network gateway 22 to interconnect two different parts of a network, e.g. different technologies. It may also be a router 24 when the main network B and the subnet SN are of the same type. Gateways and routers have similar functions, with the difference that the router does not convert the formats of data transmissions. These two network devices are intermediate elements of the communications network 14 providing for the routing of packets. Their role is to send packets from one network interface 40 to another according to a set of rules forming a routing table.

In the example of FIG. 2, two gateways 22 are connected to the backbone 20, thus forming two distinct subnets SN1 and SN2. Only one of these two subnets (‘SN1’) is described below.

In one variant, the number of subnets SN may be different.

The subnets SN are directly connected to the main network via the gateways, and have an associated first rank within the hierarchical network.

Each subnet SN contains at least one home automation device 6, 8, 10 of the home automation system 4, connected to the corresponding gateway 22 by means of a physical link 26 that is preferably wired.

The communications network 14 further includes sub-subnets having a lower rank than the subnets SN, and are generically indicated by the reference ‘SSN’.

Each sub-subnet SSN includes a network device, advantageously a router 24, which connects it to a subnet SN or a sub-subnet having a higher rank in the hierarchy than itself. The network device 22, 24 forms the head of this sub-subnet SSN.

By reference to FIG. 2, if a rank n is associated with the subnet SN1, each sub-subnet SSN1 and SSN2 is associated with a rank n−1, and the sub-subnet SSN3 has a rank n−2.

Each router 24 at the head of a sub-subnet having the rank n−1 is connected to a gateway 22 by means of a physical link 26 that is preferably wired.

If the communications network 14 includes several hierarchical levels, each network device 22, 24 at the head of a sub-subnet having the rank n−k, where k is greater than or equal to 2, is connected to a router 24 having a higher rank n−k+1 by means of a physical link 26 that is preferably wired.

In one embodiment, the hierarchical network may comprise up to twelve levels of hierarchy, including that of the main network B.

Each sub-subnet SSN includes one or more home automation devices 6, 8, 10 connected to the corresponding router 24 by means of a physical link 26, with each device being connected to the physical link 26 using their respective network interfaces 40. The home automation devices connected via a single physical link 26 to a single router 24 are said here to be part of a single local subnet.

Preferably, the subnets SN and each sub-subnet SSN having a lower rank than that of the subnet SN are each associated with a zone of the building 2.

A subnet SN and/or a sub-subnet SSN is said to be ‘associated’ with a zone Z1, Z2, Z3, Z4 of the building 2 when the home automation devices 6, 8, 10 belonging to this subnet are themselves associated with this zone, e.g. because they are physically located within this zone Z1, Z2, Z3, Z4 of the building 2.

The name and structure of the subnets SN and the sub-subnets SSN, as well as their association with the zones of the building 2, are preferably selected based on the configuration of the building 2 and the functions for which the home automation system 4 is responsible.

Preferably, the physical links 26 are RS485 or EIA-485 serial multipoint data buses.

Preferably, the physical link 26 connecting each network device 22, 24 with one another and connecting them to the home automation devices 6, 8, 10 is an RS485 serial multipoint data bus.

The use of an RS485 physical link 26 offers advantages within this communications network 14 because it makes it possible to use longer data buses, e.g. up to 1 km in length, without excessive deterioration of the quality of the signal circulating on it. The limit on the number of home automation devices 6, 8, 10 and/or network devices 22, 24 connected to a single physical link 26 is not prohibitive due to the hierarchical architecture, which allows for a large number of subnets to be connected.

Optionally, the control unit 12 is adapted to be connected to an external data network 30, e.g. the Internet, independently of the communications network 14.

In this way, the control unit 12 may communicate with a remote computer server connected to this external network 30, e.g. to send reports on the operating condition of the home automation system 4 for diagnostic purposes or to receive control instructions. The control unit 12 may also communicate via the external network 30 with one or more remote users, e.g., provided with a communications terminal such as a computer 32, a smartphone, a tablet computer, or any other equivalent device.

The communications network 14 is adapted to operate in accordance with a predefined communications protocol, e.g. the IP protocol, in order to provide for communications between the communicating devices of the home automation system 4 that are connected to the communications network 14.

In the preferred embodiment, the communications protocol used is the IPv6 protocol.

Here, this communications protocol is implemented using network interfaces 40 of the various home automation devices 6, 8, 10 and network devices 22, 24 of the home automation system 4, which are connected, in particular via their network interface 40, to the communications network 14.

In the following, the term ‘communicating device’ will be used to refer to the network devices 22, 24 and the communicating devices 6, 8, 10.

The routers 24 and the gateway(s) 22 include specific network interfaces. For example, these network interfaces each implement a protocol stack, i.e. a stack of protocol layers, with each protocol layer supported by those below it in order to provide additional functionality.

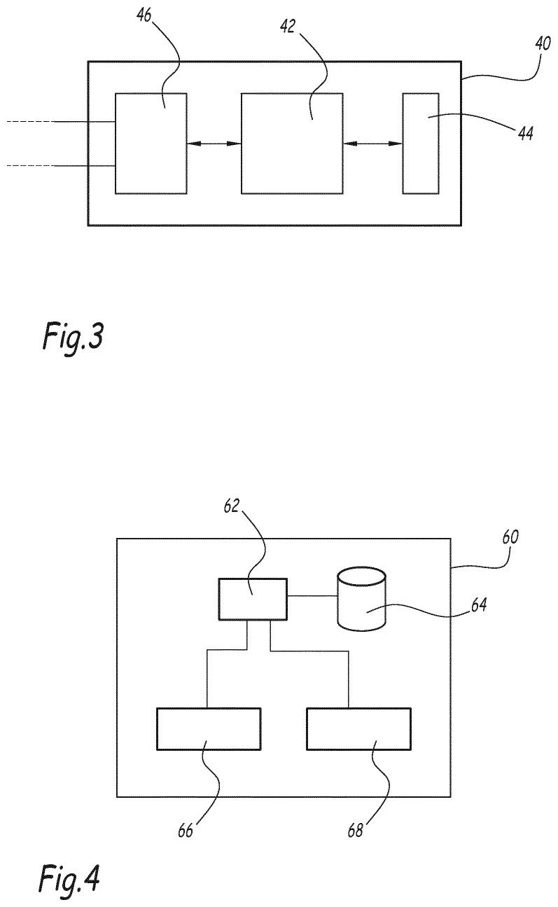

FIG. 3 is a schematic representation of the network interface of a communicating device. The network interface of a communicating device serves to connect this communicating device to one or more communication networks. It also allows it to communicate with the other communicating devices of the network(s) to which it is connected.

As shown in FIG. 3, each network interface 40 includes a network controller 42, a memory 44, and a transceiver 46; here, the transceiver 46 is provided with a connector that is arranged so as to physically connect the transceiver 46 to a physical layer of the communications network 14.

In this example, the physical layer of the communications network 14 partially consists of physical links 26.

The network controller includes a computer, e.g. one or more processors, microprocessors, or any other equivalent device, programmed to process the data passing through the communications network 14 and the connector of the transceiver 46.

For example, the network controller 42 is programmed to automatically process the data received by the transceiver 46 that are intended for the network interface 40. The processing may consist, e.g., of extracting and decoding the content of packets received over the network interface and/or transmitting this content to the home automation equipment to which it is associated.

Additionally, the network controller 42 is programmed to automatically prepare the data transmitted by the home automation device with which it is associated in order to send them to more home automation devices connected to the communications network 14.

Lastly, the network controller 42 is adapted to carry out the program code instructions that allow for the execution of the steps of the network address configuration method according to the invention.

The RS485 data buses used here, in particular, to form the physical link 26, each include a pair of conductive wires, which are preferably twisted. To transmit these data on this bus, a carrier signal is transmitted, e.g., in the form of electrical voltage between this pair of conductive wires; this voltage may take on predefined values so as to encode information, e.g. in binary format. The form of the carrier signal is defined, e.g., by standard TIA/EIA-485-A.

In this example, the link 26 is a bidirectional ‘half-duplex’ link.

Here, the memory 44 contains a network address (not shown), which uniquely identifies the interface 40 on the network 41, and thus identifies the corresponding home automation device on the network 4. The network interface 40 here is compatible with the IPv6 standard. Thus, the network address is an IP address, preferably an IPv6 address.

Additionally, the memory 44 advantageously contains executable instructions to carry out the aforementioned functions of the controller 42.

FIG. 4 is a schematic representation of a generic network device 60 for use on the network 14. The device 60 corresponds, for example, to the router 24.

This device 60 includes an electronic computer 62, a computer memory 64, a first network interface 66, and a second network interface 68. The interface 66 is intended, e.g., for connection to a first subnet, whilst the interface 68 is intended for connection to a second subnet having a lower rank than the first subnet. For example, the network interfaces 66, 68 are each physically similar to the interface 40. The device 60 includes a network address 50 that identifies it at least within the first subnet.

The electronic computer 62 is programmed, in particular, to provide for routing of data packets arriving from the part of the network associated with one or the other of the interfaces 66, 68 to a part of the communications network 14 accessible via the other interface 66 or 68 depending on the destination of the data packets. To this end, the device 60 here includes a routing table, e.g. one recorded within the memory 64.

For example, for the router 24, the interfaces 66 and 68 here are compatible with the RS485 data bus. The entire discussion of the interfaces 40 thus applies to the interfaces 66 and 68.

The gateway 22 operates similarly to the device 60 described above, except that, here, the network interface 66 is connected to the backbone 20.

The communications protocol used by the network 14 allows the messages exchanged between the elements of the home automation system 44 to be addressed by means of a packet switching mechanism.

For example, when a device of the system 4, e.g. a control point 8, must send data to another device of the system 4, e.g. a device 6, the first device will generate a message containing the data to be sent and the address of the destination device. Thus, the message is routed within the network 14 until it reaches its destination. More specifically, the message sent to a local device belonging to the same group will pass through the bus 26. A message intended for a device outside the group is routed by means of the router 24 associated with this group, which redirects it to the corresponding subnet, in some cases by means of the devices 22 and the backbone 20.

More specifically, in this example, the network protocol used within the communications network 14, and, in particular, implemented by the network interfaces 40 includes several interconnected protocol layers. These protocol layers are each implemented by the protocol stack of each network interface 40 by means of software and/or hardware, in particular by means of the network controller 42.

The home automation system 4 also includes a software application layer programmed to form a home automation system 4 according to a REST-compatible architecture (REpresentational State Transfer), also known as a ‘RESTful’ architecture.

In this software application layer, the resources that can be provided by each home automation device 6, 8, 10 and each network device 22, 24 at any time are accessible by means of an API (Application Programming Interface) implemented on the level of each communicating device 6, 8, 10, 22, 24, in particular by the associated electronic computer.

This API comprises a group of predefined functions and/or methods, preferably implemented identically on all communicating devices of the communications network 14. Thus, the resources of each home automation device 6, 8, 10 and each network device 22, 24 are represented in a uniform, standardised fashion, and are accessible to the API without any need to deal with the underlying structure of the communicating device 6, 8, 10, 22, 24.

Each communicating device 6, 8, 10, 22, 24 includes an electronic computer (not shown), which is programmed to implement this API by means of executable software instructions.

For example, this electronic computer includes one or more programmable logic units, such as a microprocessor or microcontroller.

This electronic computer also comprises a data storage medium as well as working memory. For example, the executable software instructions for the operation of the API are stored on a data storage medium. This data storage medium and this working memory may, in one variant, both be implemented on a single non-volatile data storage medium, e.g. a Flash memory.

The electronic computer of the network interface 40 allows for data to be exchanged within the communications network 14, e.g. with other nodes of the communication network that are provided with an analogous application. In particular, in each communicating device, the electronic computer is programmed to interact with the protocol stack implemented by the network interface 40, and, preferably, to interact more specifically with the protocol layer of the aforementioned network interface 40.

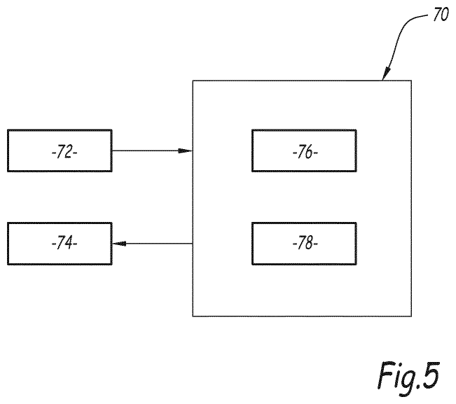

With this API, each communicating device 6, 8, 10, 22, 24 is represented in the form of one or more software objects 70, an example of which is shown generically in FIG. 5 within this application layer.

In other words, each software object 70 is a software representation of at least one part of a communicating device, implemented by the aforementioned electronic computer and incorporated within this communicating device 6, 8, 10, 22, 24. Thus, a single communicating device may include several software objects 70, preferably organised in a hierarchical tree with a ‘parent’ object comprising one or more ‘child’ software objects.

The network interface of each communicating device implements one or more software objects 70 that represent this communicating device in an abstract manner in the form of resources. The home automation system comprises three types of resources: inputs 72, outputs 74, and logical units 76. For example, each software object 70 includes one or more inputs 72, one or more outputs 74, and/or one or more logical units 76. Each of these resources has a defined state 78 that may vary over time. By way of example, the state of a wind sensor may correspond to the measured wind speed.

The state 78 here is implemented by a data structure, such as a numerical variable, a Boolean variable, or a string, which is stored in the data storage medium or the working memory.

Preferably, all of the software objects 70 are similarly structured.

The inputs 72 correspond to communicating devices that allow for data to be input to the home automation system 4. These may, for example, be sensors or control points. The data may correspond to a signal representing a physical value, e.g. a physical value associated with a home automation function in the building 2, such as a temperature, a wind speed, or a light intensity. The input data may originate from the building or its environment. The inputs 72 may also correspond to one or more databases or one or more memories, wherein the input data associated with this type of input correspond to the values stored in these databases or memories. The databases and memories comprise a network address so as to be addressable.

The outputs 74 correspond, for example, to motors and/or actuators.

The logical units 76 interpret and process the data provided by the inputs 72. The logical units 76 may be configured to carry out logical operations and/or calculation operations that are more or less complex depending on the type of input data and/or the type of application. They may, for example, be comparison operations. The logical unit may, for example, compare one or more input data with one another, or compare one or more input data with one or more predetermined threshold values. The logical unit may be configured to carry out hysteresis functions, e.g. to determine an activation delay based on an operation history, in particular in the case of management of a temperature by a heating/air conditioning system or for opening/closing a shutter based on sunshine or time. The logical units may be configured to carry out combination operations.

Once the input data have been processed by the logical unit(s), the processing result, e.g. a motor command, is transmitted to the relevant output(s). Upon receipt, the processing result will activate the relevant output.

It should be noted that the logical units are neutral. They process input data independently of their nature. A single logical unit may process data from a temperature sensor just as well as data from a wind sensor or a control point. Nor do the logical units have any knowledge of the nature of the outputs. The logical units are simply configured to modify one or more input data into one or more values to be transmitted to one or more outputs in order to control them.

The logical units are distributed over the entire communications network 14. Their placement depends neither on the inputs for which they process data nor on the outputs they control. They may be used alone or in combination with other logical units in order to carry out more complex calculations. This results in an ‘intelligent’ home automation system that may be distributed over the entire communications network 14. Moreover, this ‘intelligence’, represented by the logical units, is modular. It may be increased in size by adding other logical units 76 on the communications network 14.

The logical units may correspond to dedicated devices, i.e. ‘logic devices’ that only handle calculation functions. To this end, the home automation system 4 may optionally include logic devices (not shown) that are dedicated to logic functions accessible to the communicating devices of the communications network 14. This may be, for example, an electronic calculation server, a computer, a DSP (Digital Signal Processor), or network access storage. In the following, all discussion of the home automation devices 6, 8, 10 applies equally to such logic devices. Logic devices comprise at least one network interface to which a network address is assigned so that it can be addressed.

The logical units may be incorporated in communicating devices, e.g. a motor or control point. Thus, the control point is seen as one or more inputs 72 and one or more logical units 76 by the home automation system 4. For this reason, logical units and inputs or outputs may have the same network address. A logical unit may also be incorporated in a network device 22, 24 or a sensor 10.

Logical units may be upgraded logic devices configured so as to carry out specific home automation functions in cooperation with inputs and outputs. The specific home automation functions may, for example, be shadow management or sun tracking functions. To this end, the logical units may use the data originating from inputs of different types, such as different types of sensors (luminosity, wind, temperature, time), and data originating from databases such as sun path diagrams or TMY (Typical Meteorological Year) databases. The logical units may carry out specific operations such as combining data of different types according to one or more predefined combination formulae. These may be combinations of data related to solar orientation with data related to solar luminance in a sun tracking application.

The logical units may carry out access management operations for one or more databases, e.g. in the context of an application for managing solar gains in order to recover pre-recorded data concerning the spatial configuration of the building 2 and data related to shade due to the urban environment, or data related to a sun path diagram in order to predict the sunlight received by a façade of the building depending on the time of day.

The status of each resource 72, 74, 76 is a variable, which here is stored within the memory of the electronic computer. This variable may be an integer, a string, a Boolean value, or an array, or any other predefined data type. However, whatever data type is selected, this data type remains the same for all software objects 70. These states of the resources 72, 74, 76 may be modified by means of specific getters, or calls, defined by the API.

In this example, the API is adapted to list the resources 72, 74, 76 available on the software object 70 and to list the child software objects connected to this software object 70. This information is listed, for example, within dedicated variables that are accessible to the interface, such as string arrays.

The state 78 associated with each resource 72, 74, 76 may vary over time. Here, it is defined deterministically based on the data that enter at the inputs 72 by means of predefined rules. These rules are, for example, stored within the electronic computer associated with the home automation device 6, 8, 10.

Each resource 72, 74, 76 has an initial state 78. For example, resource receives input data over a predefined period of time at the one or more corresponding inputs 72. After this period of time, a new state 78 is calculated, which is a function of the initial state and the input data received during this period of time. This calculation is carried out based on predefined rules.

Thus, the state of an input may correspond to the measurement of a parameter or a real state of a home automation device 6, 8, 10. Likewise, the state of an output 74 may correspond to a set point related to a parameter, e.g. a position or a temperature.

Thus, the behaviour of each home automation device 6, 8, 10 is deterministic, and depends on the interactions between this home automation device and its outside; these interactions may be measured and monitored. The state of each home automation device 6, 8, 10 is accessible to the other home automation devices 6, 8, 10 connected to the communications network 14 by means of the API, and the state of the home automation device may correspond to the state of a resource associated with that device. This type of resource-orientated architecture differs from known-art home automation systems that comprise a control unit, in which there is no way for the other home automation devices to know the state of a device at a given time except via the control unit.

Each device 6, 8, 10 is programmed, by means of the aforementioned electronic computer, to respond automatically to requests originating from other nodes of the network, e.g. by means of an HTTP (Hypertext Transfer Protocol) server.

For example, these requests are contained in messages circulating on the communications network 14. For example, these messages are exchanged by means of the UDP (User Datagram Protocol).

For example, each message contains an identifier of the target home automation equipment 6, 8, 10, as well as one or more commands that may be accompanied by parameters or variables associated with these commands.

For example, the API uses protocols comprising HTTP requests. By way of example, the commands correspond to known http commands, such as GET, POST, PUT, REPLY, or DELETE.

Each software object 70 here is identified within the application protocol of the home automation system 4 by a unique access path. For example, this path may be a URI (Uniform Resource Identifier). For example, this path may be a string of predefined alphanumeric characters and/or symbols.

Furthermore, each one may act as an HTTP proxy, relaying messages to other home automation devices of the communications network 14.

Advantageously, the API includes a function allowing for verification of the state of one or more properties 76 of the software object 70, e.g. to obtain a list of resources of the home automation device. Thus, this function will return this list of properties when it is called by means of a corresponding request. For example, this list is transmitted to the originator of the request in the form of one or more messages on the communications network 14.

The software interface also includes an ‘introspection’ function that, for each software object 70, implements a discovery function in order to recursively list all child software objects associated with that software object 70 so as to create one or more lists of their respective properties.

The API is also implemented on the network devices such as the gateways 22 and the routers 24, e.g. by means of their respective computers 62. In this way, a subnet may be represented by such a software object 70, the resource of which then correspond to the whole of the individual resources of each of the home automation devices 6, 8, 10 belonging to the subnet. The software objects 70 associated with these home automation devices, in this case, are seen as child software objects attached to a software object 70 associated with the network device 22, 24 to which the home automation devices are connected.

An input resource may be simply associated with a wind sensor, and the state of the resource will be equivalent to a wind speed value at a time t. A logical unit resource may be associated with one or more routers of the communications network, which also manages an output resource. In this example, the logical unit may be defined by a comparison with a predetermined wind value, and the output by a command to retract awning-type devices. For example, the command is transmitted on the network. Such a device receiving such a command will react accordingly. This same device may have an input resource, into which its state will be entered during the execution of the command and upon completing the execution of the command. The state of this input resource may then be used in order to confirm the execution of the command.

In other words, due to the nature of the API, any subsystem SN, SSN of the communications network may be seen as a full system, modelled independently of the rest of the communications network 14 and described globally in terms of inputs, outputs, and resources of home automation devices 6, 8, 10 belonging to this subnet.

Due to this architecture and the programming of these resources, a subnet comprising home automation devices 6, 8, 10 may be considered a full-scale home automation subsystem, which may, if needed, operate independently of the rest of the system 4, e.g. in case of a malfunction that leaves the subnet isolated from the rest of the communications network 14 and unable to communicate with it. Likewise, the rest of the home automation system 4 may continue operating when certain components, e.g. the home automation devices 6, 8, and 10, are unavailable or cannot be reached.

This differs from the known-art home automation systems, in which the operation of the home automation devices depends on the control unit, e.g. home automation systems based on a master-slave configuration. In such home automation systems, logical operations are carried out by the control unit in a centralised manner. Thus, if the communications network should fail, e.g. due to a cable being accidentally cut, resulting in the isolation of one or more of the home automation devices from the control unit, they will no longer be able to operate automatically. These home automation devices may certainly be controlled manually, e.g. by means of a local control point connected to the home automation device by a wired connection, but they will no longer be able to function according to an automatic program, e.g. based on values measured by the sensors, because the logic functions are only implemented by the central unit, to which they no longer have access.

On the other hand, because the logic resources are distributed on the various subnets within the communications network 14, it remains possible for devices to operate based on automatic rules. In fact, in such an example, the network equipment and/or home automation equipment in question may find the logic resources necessary for its operation, e.g. by exploring the software interfaces of the software objects corresponding to the home automation devices to which it is still connected. In other words, the intelligence of the home automation system 4 is distributed within the communications network 14. Thus, the control unit 12 may be omitted, and the network can function autonomously.

The invention also concerns a method for configuring a home automation system 4 for a building 2. This method may be executed by a configuration device in order to configure the home automation system 4. To this end, the configuration tool may comprise a configuration module programmed to execute the configuration method. Let us assume that the home automation system comprises a plurality of communicating devices 6, 8, 10, 22, 24 configured to carry out a plurality of home automation functions and a communications network 14 to which the communicating devices are connected,

In order to configure the home automation system, the installer connects the configuration device to any point on the communications network and runs a discovery procedure in order to determine the communicating devices 6, 8, 10, 22, 24 present in the home automation system.

A map of the various resources 72, 74, 76 offered by each communicating device discovered in the communications network is then generated. During this mapping step, the configuration device may scan each communicating device discovered in order to enumerate the resources 72, 74, 76 they offer and determine what functions they are capable of carrying out. This assumes that the communications protocol is capable of introspection, i.e. that each communicating device is capable of introspection in order to run through its tree and discover the various software objects it has and can implement.

The configuration device may also associate a URI with each resource enumerated. The URI contains the network address of the network interface of the communicating device modelled, at least in part, by the resource.

The home automation functions of the home automation system 4 are then programmed, taking into account the map of the resources 72, 74, 76 on the communications network 14. The programming step consists of establishing links between the inputs 72, logical units 76, and outputs 74 and configuring the logical units 76 in order to process data provided by the inputs 72 and transmit the result of the processing to the outputs 76 in order to control them.

The programming step also consists of transmitting the links established to at least certain resources, thus allowing the network to operate autonomously.

In particular, the state of a logical unit resource may comprise not only a function, but also the links established during programming, e.g. identification of the input resource to recover and the output resource to update.

In order to carry out a home automation function, the data provided by one or more inputs may be processed by a single logical unit, or the processing may be divided between several distinct logical units distributed within the communications network 14.

In a startup mode, the links between the inputs, logical units, and outputs may be established automatically by the configuration device.

To this end, the programming device may comprise one or more libraries of home automation functions, e.g. stored in a memory area of the device. This function library allows the configuration tool to know the types of resources necessary to carry out each home automation function. In other words, for example, the links between the inputs, logic units, and outputs are established automatically by the configuration device based on the libraries of home automation functions.

By way of example, the library may indicate that, in order to carry out a sun protection function, the system needs one or more inputs configured to provide data corresponding to luminosity information, one or more logical units capable of processing the data provided by the inputs and transmitting the processed data to one or more outputs. For example, the logical unit may be programmed to compare the data provided by the input(s) with a predetermined threshold value and, when this threshold value is reached, transmit a command to a motor, e.g. in order to lower an awning.

The configuration method may be executed automatically by the configuration device after it has been connected to the communications network 14.

Another object of the invention is a method for maintaining a home automation system for a building. Let us assume that the home automation system has previously been configured, e.g., by the aforementioned configuration method. The maintenance method may be executed by a maintenance tool. In one embodiment, the maintenance tool and the aforementioned configuration tool may be identical.

The maintenance tool may be connected to any point on the communications network. The maintenance method comprises discovering the communicating devices 6, 8, 10, 22, 24 present in the home automation system, mapping resources 72, 74, 76 offered by each communications device discovered on the communications network 14, and recovering the various links between the resources of each communicating device discovered, as well as their status. As described above, the step of resource mapping may comprise a sub-step of enumerating the resources 72, 74, 76 offered by each communicating device discovered and a sub-step of associating a resource identifier with each resource enumerated.

The method may comprise a step of reprogramming home automation functions of the home automation system 4. This reprogramming may be carried out whilst taking into account a new map of the resources 72, 74, 76 on the communications network 14 and/or new home automation functions to be carried out.

The maintenance method may comprise a step of correcting defective resources and/or links, e.g. following one or more malfunctions in the home automation system.

For example, the maintenance method may be executed following the addition of new communicating devices to the home automation system and/or the provision of new home automation functions compared to an initial configuration. The programming step may thus consist of establishing links between the inputs, logical units, and outputs and configuring the logical units in order to process data provided by the inputs and transmit the result of the processing to the outputs in order to control them.

In one embodiment, the maintenance tool may save a previous configuration of the home automation system in a memory area. This old configuration may be compared to the current configuration of the home automation system, e.g. in order to detect any malfunctions and/or failures in the home automation system. This comparison may also be for the purpose of discovering new communicating devices installed since the last intervention.

The installation and maintenance of the home automation system are also facilitated. Indeed, if an installer wishes to check the state of the home automation system 4, e.g. to add network devices or home automation devices, or to carry out a diagnostic, they will not always know in advance what network or home automation devices are already installed or how they interact with the rest of the home automation system 4. Due to the invention, it will suffice to execute the steps of detecting resources within the home automation system 4, either at the level of the home automation system 4 as a whole or at the level of one or more subnets, or at the level of one or more network or home automation devices, in order to list the resources available and their respective states. For example, this is done by connecting a client terminal, e.g. a computer or mobile communications device connected to the communications network 14, equipped with a screen, and adapted to access the software interface and show a list or map of the various resources.

In particular, when the subnets SN, SSN are associated with zones of the building 2, the software interface makes it easy to list the resources offered by the home automation devices associated with these zones as well as their associated inputs/outputs.

This allows for better visualisation of the system 4 and its state.

The embodiments and variants discussed above may be combined to generate new embodiments.

1. A method for configuring a home automation system for a building executed by a configuration device, wherein the home automation system comprises a plurality of communicating devices configured to carry out a plurality of home automation functions and a communications network to which the communicating devices are connected, wherein each communicating device comprises a network interface having a network address and implementing one or more software objects that model the communicating device in the form of resources of at least three types: input, output, and logical unit,
wherein the method comprises:
discovering the different communicating devices of the communications network,
mapping the resources offered by each communications device discovered on the communications network,
programming home automation functions of the home automation system, taking into account the map of the resources on the communications network.

2. The method of claim 1, wherein the step of resource mapping comprises a sub-step of enumerating the resources offered by each communicating device discovered and a sub-step of associating a resource identifier with each resource enumerated.

3. The method of claim 1, wherein the programming step consists of establishing links between the inputs, logical units, and outputs and configuring the logical units in order to process data provided by the inputs and transmit the result of the processing to the outputs in order to control them.

4. The method of claim 3, wherein the programming step consists of transmitting the links established to at least some resources.

5. The method of claim 4, wherein the links between the inputs, the logical units, and the outputs are automatically established by the configuration device depending on libraries stored in a memory zone of the configuration device.

6. The method according of claim 3, wherein the execution of the method is divided between several distinct logical units distributed within the communications network.

7. The method of claim 1, wherein the method is automatically executed by the configuration device after said configuration device is connected to any point on the communications network.

8. A home automation system for a building, wherein the home automation system is configured by the configuration method according to claim 1, wherein the home automation system comprises a plurality of communicating devices configured to carry out a plurality of home automation functions and a communications network to which the communicating devices are connected, wherein each communicating device comprises a network interface having a network address and implementing one or more software objects that model the communicating device in the form of resources of at least three types: input, output, and logical unit.

9. The home automation system of claim 8, wherein each resource is identified by a unique resource identifier containing the network address of the network interface of the communicating device modelled, at least in part, by the resource.

10. The home automation system of claim 8, wherein a sensor or a control point is modelled in the form of at least one input.

11. The home automation system of claim 8, wherein a controllable home automation device is modelled in the form of at least one output.

12. The home automation system of claim 8, wherein a network device is modelled in the form of at least one logical unit.

13. The home automation system of claim 12, wherein the communications network is arranged in the form of a hierarchical network.

14. A method for maintaining the home automation system for a building according to claim 8, wherein the maintenance method omprises:
discovering different communicating devices of the communications network,
mapping resources offered by each communications device discovered on the communications network,
recovering the various links between the resources of each communicating device discovered, as well as their status.

15. The method of claim 14, wherein said method further comprises reprogramming home automation functions of the home automation system whilst taking into account a new map of the resources on the communications network and/or new home automation functions to be carried out.

16. The method of claim 14, wherein said method further comprises correcting defective resources and/or defective links.

17. The method of claim 2, wherein the programming step consists of establishing links between the inputs, logical units, and outputs and configuring the logical units in order to process data provided by the inputs and transmit the result of the processing to the outputs in order to control them

18. The method according of claim 4, wherein the execution of the method is divided between several distinct logical units distributed within the communications network.

19. The method according of claim 5, wherein the execution of the method is divided between several distinct logical units distributed within the communications network.

20. The method of claim 2, wherein the method is automatically executed by the configuration device after said configuration device is connected to any point on the communications network.
